(19) United States
(12) Patent Application Publication
(10) Pub. No.: US 2008/0271753 A1
(43) Pub. Date: Nov. 6, 2008

(54) METHOD OF CLEANINIG STANNANE DISTRIBUTION SYSTEM

(75) Inventors: Kohei TARUTANI, Tsukuba-shi (JP); Hideyuki Sato, Ibaraki-ken (JP); Cheng-Fang Hsiao, Tsukuba-shi (JP)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme pour I'Etude et I'Exploitation des Procedes Georges Claude, Paris (FR)

(21) Appl. No.: 12/115,295

(22) Filed: May 5, 2008

Related U.S. Application Data
(60) Provisional application No. 60/915,876, filed on May 3, 2007.

(51) Int. Cl. B08B 7/00

(52) U.S. Cl. 134/4

(57) ABSTRACT

Methods for cleaning a stannane distributions system. A stannane distribution system connecting a stannane supply source and a semiconductor manufacturing tool is provided. Stannane is flown through the system, and a tin layer is formed on the components of the distribution system. This tin layer is then cleaned from the distribution system without the use of liquid cleaning chemicals.

### CROSS REFERENCE TO RELATED APPLICATIONS

The present application claims the benefit of U.S. Provisional Application Ser. No. 60/915,876, filed May 3, 2007 herein incorporated by reference in its entirety for all purposes.

### BACKGROUND

1. Field of the Invention

This invention relates generally to the field of semiconductor fabrication. More specifically, the invention relates to a method of cleaning a stannane distribution system used in semiconductor manufacture.

2. Background of the Invention

Stannane (SnH₄) is a volatile tin species that does not contain any carbon or halide atoms. The material characteristics of stannane make it one of the leading candidates for use in generating light for Extreme Ultra Violet (EUV) semiconductor manufacturing processes. Currently EUV processes use xenon gas in light generation processes, but it is thought that as the industry requires a higher power density, tin based sources will be preferred.

Stannane is decomposes readily, and even stored under controlled conditions, it will decompose into tin and hydrogen. If handled improperly (heat/pressure/etc), stannane can undergo a rapid exothermic decomposition which can cause concerns from a safety standpoint for material handing and distribution. Tin, as one of the decomposition products of stannane, also acts as a catalyst for stannane decomposition such that the more tin present, the more rapidly the stannane will decompose.

Storage and distribution systems for stannane will necessarily see decomposition of stannane during their use, resulting in a layer of tin deposited within the components of the distribution systems (e.g. piping, valves, filters, flow controllers, etc). For these distribution systems to function efficiently, this layer of tin will need to be periodically removed or cleaned.

It is known that tin can be removed from metallic surfaces such as steel using an aqueous acid solution, however wet chemical cleaning methods of semiconductor material distribution systems can be difficult in that wet methods normally require a lot of physical intervention to the distribution system which is difficult to automate, can generate large amounts of liquid waste which may be difficult to dispose of, and can introduce other impurities into the system. Additionally, wet methods leave behind moisture which must be removed from the system before it can be placed into service, and this can be a time consuming process.

Consequently, there exists a need for a method to clean stannane supply and distribution systems without the use of wet cleaning solutions.

### BRIEF SUMMARY

Novel methods for cleaning a stannane distribution system are described herein. The disclosed methods utilize a cleaning gas mixture for so called dry cleaning as opposed to the introduction of liquid cleaning solutions.

In an embodiment, a method for cleaning a stannane distribution system comprises, a providing stannane distribution system which connects at least one stannane supply source to at least one semiconductor manufacturing tool. Stannane is flown through the distribution system, and a layer of tin is formed on at least part of the distribution system by a decomposition of at least part of the stannane. The distribution system is cleaned of at least part of the tin through a dry cleaning method which is performed in the absence of liquid cleaning chemicals.

Other embodiments of the current invention may include, without limitation, one or more of the following features:
providing a cleaning gas mixture supply source connected to the distribution system;
the cleaning gas mixture supply source contains a cleaning gas mixture which comprises a halogen;
introducing the cleaning gas mixture from the cleaning gas mixture supply source to the distribution system;
the cleaning gas mixture comprises chlorine;
the cleaning gas mixture comprises an additive selected from at least one of HCl, HBr and H₂;
the cleaning gas mixture comprises between about 0.1% and about 20% of the additive;
introducing the cleaning gas mixture at a pressure between about 60 torr and about 30 torr;
maintaining the pressure of the cleaning gas mixture within the distribution system within a tolerance of about 10% of the pressure at which the cleaning gas mixture is introduced;
introducing the cleaning gas mixture while exposing the distribution system to a vacuum;
purging the distribution system with an inert gas prior to the cleaning step;
exposing the distribution system to a vacuum after the introduction of the inert gas;
purging the distribution system with an inert gas after the cleaning step, and then exposing the distribution system to a vacuum;
taking at least one measurement at a point upstream on the distribution system;
taking at least one measurement at a point downstream on the distribution system;
comparing the two measurements to determine if the distribution system has been sufficiently cleaned of the deposited tin;
the upstream measurement and the downstream measurement are both pressure measurements;
the upstream measurement and the downstream measurement are both mass flow measurements;
the distribution system is cleaned for a set period of time;
at least about 50%, preferably about 99%, of the deposited tin is removed from the distribution system; and
substantially all the cleaning gas is removed from the distribution system and stannane is reintroduced into the distributions system.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates a schematic of a system for capable of implementing one embodiment of the current invention;

FIG. 2 illustrates graphical results of the effect of tin build up in a mass flow controller used in a stannane distribution system; and

FIG. 3 illustrates graphical results of the relationship between pressure and cleaning rate, according to one embodiment of the current invention.

### DESCRIPTION OF PREFERRED EMBODIMENTS

Generally, a method for cleaning a stannane distribution system comprises, providing stannane distribution system which connects at least one stannane supply source to at least one semiconductor manufacturing tool. Stannane is flown through the distribution system, and a layer of tin is formed on at least part of the distribution system by a decomposition of at least part of the stannane. The distribution system is cleaned of at least part of the tin through a dry cleaning method which is performed in the absence of liquid cleaning chemicals.

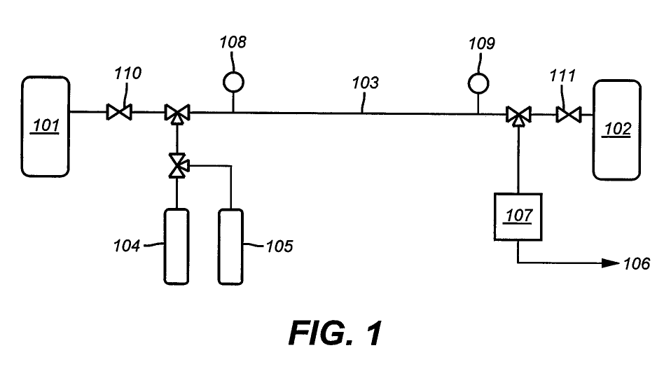

Referring now to FIG. 1, various embodiments of methods according to the invention are described hereafter. A stannane distribution system 100 is shown, which connects a stannane supply source 101 with a semiconductor manufacturing tool 102. In some embodiments, the stannane supply source 101 may be a conventional gas supply source such as a compressed gas storage vessel, and the semiconductor manufacturing tool 102 may be a EUV type tool. Connecting the stannane supply source 101, with the semiconductor manufacturing tool 102 is a conduit 103 which is suitable to place the stannane supply source 101 in fluid communication with the tool 102. In some embodiments conduit 103 may be piping or tubing, and may have various other elements disposed along it, such as valves, gages, mass flow controllers, regulators, and the like as would be know by one of skill in the art. In some embodiments, conduit 103 is made of a material which is suitable for use in semiconductor manufacturing processes, such as stainless steel.

In some embodiments, a cleaning gas mixture supply source 104 is provided. The cleaning gas mixture supply source 104, which may be a conventional gas supply source such as a compressed gas storage vessel, or a connection to another bulk supply source, and the cleaning gas mixture supply source 104 contains a cleaning gas mixture which comprises a halogen. In some embodiments, the cleaning gas mixture may also comprise an additive in an amount between about 0.1% and about 20%, by volume, which aids in the cleaning process. In some embodiments the halogen is chlorine and the additive is HCl, HBr, or H₂. The cleaning gas mixture supply source 104 may also be in fluid communication with the semiconductor manufacturing tool 102 through a conduit (not shown) other than conduit 103 so that cleaning gas may be supplied directly to the semiconductor manufacturing tool 102.

An inert gas supply source 105 is provided in some embodiments. Inert gas supply source 105, which contains an inert gas (e.g. N₂, Ar, He, etc.) may be a conventional type supply source such as a compressed gas cylinder, or a connection to a bulk inert gas supply system. In some embodiments, a vent line 106 is provided on the stannane distribution system 100. Vent line 106 is disposed downstream of the stannane supply source 101, and upstream of the semiconductor manufacturing tool 102, and is suitable to send empty or vent the stannane distribution system 100 as would be understood by one of skill in the art. In some embodiments, a vacuum generator is also provided 107. Vacuum generator may be a conventional vacuum generator (e.g. a venturi type vacuum generator) as would be understood by one of skill in the art.

In some embodiments at least two sensors 108, 109 capable of taking a measurement are disposed on the distribution system 100. At least one of the two sensors 108, 109 is located at a point upstream on the distribution system 100, while at least one of the sensors 108,109 is located at a point downstream on the distribution system 100. In some embodiments, sensors 108, 109 are both pressure sensors, while in other embodiments, sensors 108, 109 are both mass flow meter type sensors. Generally, sensors 108, 109 are both the same type of sensor.

When stannane is introduced into stannane distribution system 100 from the stannane supply source 101, for instance by opening valve 110, stannane flows through the conduit 103 towards semiconductor manufacturing tool 102 (which itself may be isolated from the distribution system 100 by valve 111). Since stannane decomposes easily into tin and hydrogen at room temperature, some stannane decomposes in the distribution system 100 as it flows towards the tool 102, forming a layer of tin within and/or on the components of distribution system 100.

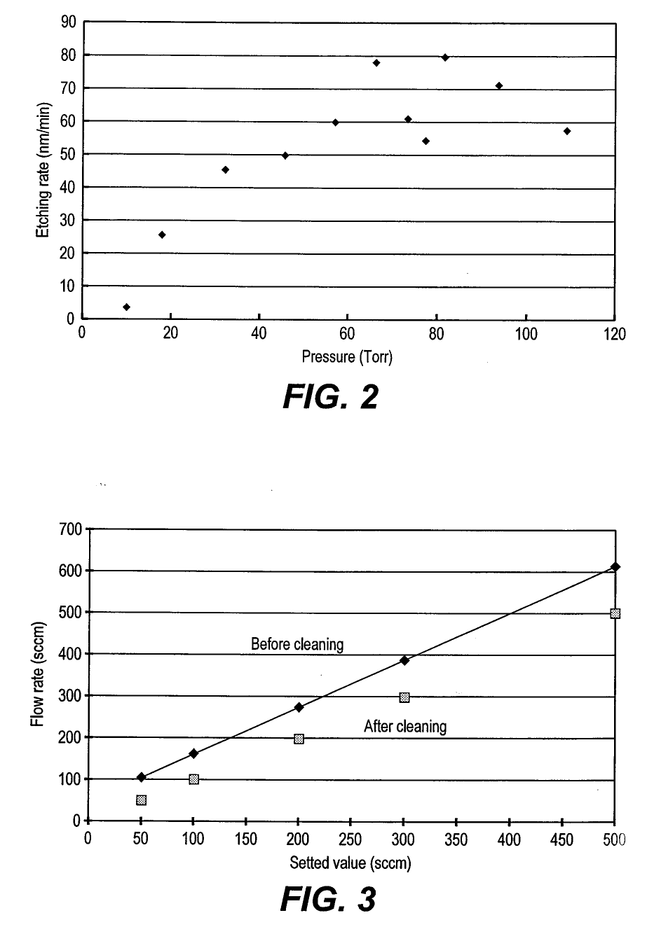

In some embodiments, after stannane has flown through distribution system 100 for a certain period of time (e.g. for greater than 100 hours) at least part of the stannane will have decomposed to form a layer of tin in the distribution system. This layer of tin may be of a certain thickness (e.g. 100 nm) and periodic cleaning of this layer of tin is necessary as its presence can degrade component performance, and also because the presence of the tin can act as a catalyst to increase the decomposition rate of the stannane. FIG. 2, shows an example of a standard mass flow controller which was used in stannane service. Results of the mass flow controller's actual flow rate versus its set flow rate, pre and post tin cleaning, show that the presence of tin in and on the mass flow controller degraded its performance.

The distribution system 100 is cleaned with the cleaning gas mixture contained in the cleaning gas mixture supply source 104. In embodiments where the halogen in the cleaning gas mixture is chlorine, the chlorine reacts with the deposited tin according to the following equation, to form tin tetrachloride:

Sn+2Cl₂→SnCl₄

Cleaning distribution system 100 in this manner allows a dry cleaning method using only gaseous products (cleaning gas and waste products), which are easily purged from the system and are not as maintenance intensive as methods which require wet chemicals for cleaning.

In some embodiments according to the current invention, to clean the tin deposited in the distribution system 100, the stannane supply source 101 is isolated from the distribution system 100, for instance by closing valve 110. In some embodiments, valve 110 may be a three way type diverter valve which diverts the stannane to a second distribution system (not shown) connected to tool 102 so that the semiconductor manufacturing tool 102 may operate without interruption in supply of stannane while distribution system 100 is being cleaned. Valve 111 may also be closed to isolate distribution system 100 from tool 102, and valve 112 may be opened to vent 106. Inert gas from inert gas supply 105 may then be introduced to distribution system 100 to purge any remaining stannane gas from distribution system 100 to vent 106. Vacuum source 107 may also be used to pull a vacuum on distribution system 100 (that is, expose the system to a negative pressure) in order to expedite the purging of the distribution system 100, which may then be cycle purged with inert gas and vacuum, as would be known to one of skill in the art.

In some embodiments, after the distribution system 100 has been purged, cleaning gas may be introduced from cleaning gas supply source 104. In embodiments where the cleaning gas mixture comprises chlorine, it is important to monitor the pressure of the cleaning gas as it enters the distribution system 100. FIG. 3 shows a graphical representation of the cleaning or etching rate of a chlorine based cleaning gas mixture on tin, versus the pressure of the cleaning gas mixture. A linear relationship exists for pressures up to about 60 torr. In some embodiments the pressure of the cleaning gas introduced into distribution system 100 is monitored in a conventional manner such as with a pressure gage, to make sure that the pressure of the gas remains below 60 torr, or within a pressure range tolerance of about 10%, which optimizes the cleaning rate and decreases the heat generation from the reaction between tin and chlorine.

In some embodiments, cleaning gas may be flown through distribution system 100 and to vent 106 in a dynamic manner, and vacuum generator may continue to pull a vacuum on the system so as to keep the pressure in the system reduced. In other embodiments, the cleaning gas may be introduced in a static manner such that the system 100 is pressurized with cleaning gas for a period of time, for instance, by isolating vent line 106 with valve 112, and then opening valve 112 at a later time.

In some embodiments, distribution system 100 is cleaned for a set amount of time (e.g. 1 hr, 1% of operating time, etc), and in other embodiments the system 100 is cleaned for an amount of time determined to be effective to remove at least 50%, and preferably 99% of the tin deposited.

In some embodiments, the length of time to effectively clean the distribution system 100 can be determined by using pressure sensors as sensors 108, 109 and by introducing the cleaning gas mixture at a pressure greater than about 30 torr, but less than 60 torr, and then by isolating the system from vent 106. The pressure in the line is then monitored with pressure sensors 108 or 109. Since the vapor pressure of tin tetrachloride, the byproduct of the cleaning, is about 30 torr at room temperature, the pressure in the line will decrease towards 30 torr if tin is still present in the distribution system 100 since the reaction between the tin and the cleaning gas will continue. If the pressure decreases in this way, vent line 106 can be reopened and cleaning can continue until subsequent checks do not show a pressure drop indicative of excessive tin presence (e.g. greater than 100 nm deposited).

In some embodiments the length of time to effectively clean the distribution system 100 can be determined by using mass flow meters as sensors 108,109. When at least one sensor 108 is located upstream of the distribution system 100, it will read a lower mass flow rate indicative of less SnCl₄, while the at least one sensor 109 located downstream on the distribution system 100 will read a higher mass flow rate indicative of more tin tetrachloride. The readings of these sensors can be monitored, and as less tin is present in the system 100, the reading of the upstream sensor 108 will approach the reading of the downstream sensor 109, such that the ratio of the two will approach 1.

In some embodiments the system 100 is cleaned for such a length of time as to remove at least 50% of the tin present, and preferably to remove about 99% of the tin present.

After the cleaning is sufficiently performed, the flow of cleaning gas from cleaning gas supply system 104 may be stopped, and the distribution system 100 may be cycle purged with the inert gas from inert gas source 105, and the vacuum from vacuum source 107, such that all the cleaning gas is purged from the system 100. Stannane may then be reintroduced into the system, by opening valve 110, and valve 111 may be opened so that tool 102 is again supplied with stannane.

While embodiments of this invention have been shown and described, modifications thereof can be made by one skilled in the art without departing from the spirit or teaching of this invention. The embodiments described herein are exemplary only and not limiting. Many variations and modifications of the composition and method are possible and within the scope of the invention. Accordingly the scope of protection is not limited to the embodiments described herein, but is only limited by the claims which follow, the scope of which shall include all equivalents of the subject matter of the claims.

What is claimed is:

1. A method of cleaning a stannane distribution system, comprising:
a) providing a stannane distribution system which connects at least one stannane supply source to at least one semiconductor manufacturing tool;
b) flowing stannane through the stannane distribution system;
c) forming a layer of tin on at least part of the stannane distribution system by decomposing part of the stannane; and
d) cleaning the distribution system of at least part of the tin, wherein the cleaning is a dry cleaning performed in the absence of liquid cleaning chemicals.

2. The method of claim 1, further comprising:
a) providing a cleaning gas mixture supply source connected to the distribution system, wherein the cleaning gas mixture supply source contains a cleaning gas mixture which comprises a halogen; and
b) introducing the cleaning gas mixture from the cleaning gas mixture supply source to the distribution system.

3. The method of claim 1, wherein the cleaning gas mixture comprises chlorine.

4. The method of claim 3, wherein the cleaning gas mixture further comprises at least one additive selected from the group consisting of: HCl, HBr, and H₂.

5. The method of claim 4, wherein the cleaning gas mixture comprises between about 0.1% and about 20%, by volume, of the additive.

6. The method of claim 2, further comprising introducing the cleaning gas mixture at a pressure of less than about 60 torr.

7. The method of claim 6, further comprising introducing the cleaning gas mixture at a pressure greater than about 30 torr.

8. The method of claim 2, further comprising maintaining the pressure of the cleaning gas mixture within the distribution system within a tolerance of 10% of the pressure at which the cleaning gas mixture is introduced.

9. The method of claim 2, further comprising introducing the cleaning gas while exposing the distribution system to a vacuum.

10. The method of claim 1, further comprising purging the distribution system with an inert gas prior to the cleaning step.

11. The method of claim 10, further comprising exposing the distribution system to a vacuum after the introduction of the inert gas.

12. The method of claim 1, further comprising purging the distribution system with an inert gas after the cleaning step.

13. The method of claim 12, further comprising exposing the distribution system to a vacuum after the introduction of the inert gas.

14. The method of claim 2, further comprising
a) taking at least one measurement at a point upstream on the distribution system;
b) taking at least one measurement at a point downstream on the distribution system; and
c) comparing the two measurements to determine if the distribution system has been sufficiently cleaned of deposited tin.

15. The method of claim 14, wherein the upstream measurement and the downstream measurement are both pressure measurements.

16. The method of claim 14, wherein the upstream measurement and the downstream measurement are mass flow measurements.

17. The method of claim 2, further comprising cleaning the distribution system for a set period of time.

18. The method of claim 2, further comprising cleaning at least about 50% of the deposited tin from the distribution system.

19. The method of claim 18, further comprising cleaning at least about 99% of the deposited tin from the distribution system.

20. The method of claim 2, further comprising removing substantially all of the cleaning gas from the distribution system and reintroducing stannane into the distribution system.
